(19) United States
(12) Patent Application Publication
(10) Pub. No.: US 2007/0172090 A1
(43) Pub. Date: Jul. 26, 2007

(54) Portable earphone-microphone type digital music player

(76) Inventors: Ter-Tsai Chiu, Taipei County (TW); Tsung-Chieh Lee, Kaohsiung City (TW)

Correspondence Address: TER-TSAI CHIU, P.O. Box 44 - 2049, Taipei, 10668, omitted

(21) Appl. No.: 11/543,063

(22) Filed: Oct. 5, 2006

(30) Foreign Application Priority Data
Jan. 24, 2006 (TW) 095201603

(51) Int. Cl. H04R 25/00

(52) U.S. Cl. 381/375; 381/370

(57) ABSTRACT

The present invention discloses a portable earphone-microphone type digital music player capable of playing MIC sounds and comprises two insert holes on a body of the digital music player, and the two insert holes are an earphone output hole and a microphone (Mic or Line-in) input hole, and a select switch and a signal sensitivity adjusting knob are provided for switching a play function of the microphone (Mic) or a recording function of the Line-in microphone, and adjusting the input of a sound volume of said microphone or Line-in. If the play function of the microphone is selected, the signal sensitivity adjusting knob can be used for adjusting the input sound volume of the microphone.

### BACKGROUND OF THE INVENTION

(1) Field of the Invention

The present invention relates to a digital music player, and more particularly to a portable earphone-microphone type digital music player capable of playing MIC sounds.

(2) Description of the Prior Art

In the present consumer electronic industry, portable music players become increasingly popular due to its compact size and long battery life. However, consumers constantly demand more functions such as integrating a faster processor for the videoconferencing coding and decoding, continuously increasing the memory capacity, or even incorporating an instant recording function, such that the portable music players can integrate many functions to provide a multifunctional portable multimedia player. The major advantage of such portable multimedia player (PMP) resides on that consumers can listen to a radio, watch a TV channel or view other multimedia document while conducting other activities.

However, a general standard compact portable digital music player usually comes with an earphone jack for connecting an earphone, and a high-end model may have a Line-In (Video Input) socket for recording sounds, so as to achieve the so-called language learning function. Most users like to sing along with the music played on the portable multimedia player while listening and enjoying the digital music, but they cannot listen to their own voice or song since the earphone blocks the sound in the air, and cannot provide a comprehensive self-entertaining effect. Similarly, such effect also applies to the language learning function, and users cannot follow and repeat the pronunciation of a new word, or make corrections immediately, and thus it will adversely affect the learning effect.

If a user can listen to their own song while listening to the music played by a portable multimedia player, or listen to their pronunciation of new words, then the self-entertaining effect as well as the language learning effect can be enhanced significantly.

### SUMMARY OF THE INVENTION

Therefore, it is a primary objective of the present invention to overcome the shortcomings of the prior art by providing a portable earphone-microphone type digital music player capable of playing MIC sounds. The design of its body comprises two insert holes: an earphone output hole and a microphone (Mic or Line-in) input hole, and a select switch and a signal sensitivity adjusting knob are provided for switching the play function of the microphone Mic or a recording function of a Line-in. If the play function of the microphone is selected, the signal sensitivity adjusting knob can be used for adjusting the input sound volume of the microphone Mic. When the invention is in use, the plugs of the earphone and the microphone of the earphone-microphone module are plugged into the two insert holes respectively. After a user wears the earphone-microphone module, the user can sing along with the music while listening to the music, since there is an extra microphone Mic for the play function that can integrate the user's song with the music and send the sound to the user's ear. Further, the input sound volume of the microphone can be adjusted by the signal sensitivity adjusting knob, so that the sound can be boosted or the background sound can be reduced to achieve an entertaining effect similar to portable KTV or Karaoke.

In addition, a user can select the language learning function, such that the user can follow or repeat the pronunciation of new words, and make proper corrections if needed, since the user can clearly listen to his/her own voice, so as to greatly improve the language learning effect. The users also can correct any mistake made in the process of learning a language if they can hear their own voice clearly, and thus the present invention can significantly improve the learning effect.

The objectives, shape, structure, apparatus, characteristics and effects will become apparent by the detail description together with the accompanying drawings. Of course, some of the elements of the present invention may be substituted by their equivalents, and the detailed description of preferred embodiments given in the specification illustrates the structure of the invention.

### BRIEF DESCRIPTION OF THE DRAWINGS

FIG. 1 is a block diagram of the structure in accordance with a preferred embodiment of the present invention.

### DETAILED DESCRIPTION OF THE PREFERRED EMBODIMENTS

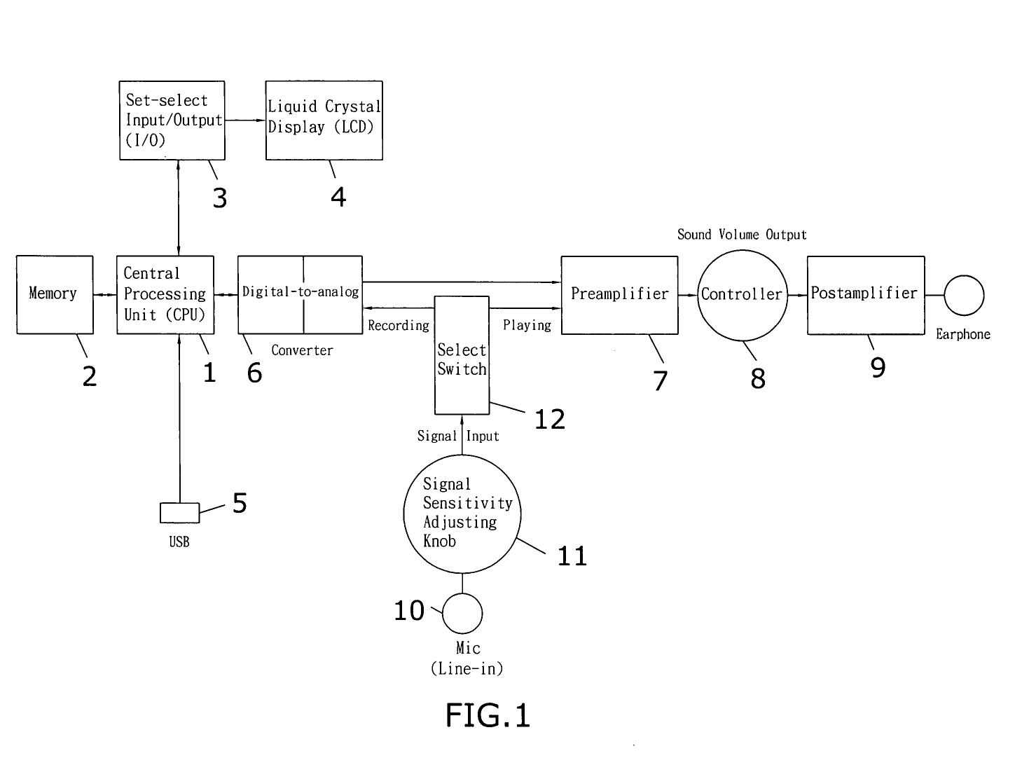

Referring to FIG. 1 for a portable earphone-microphone type digital music player capable of playing MIC sounds, the portable earphone-microphone type digital music player comprises: a central processing unit (CPU) 1, a memory 2, a set-select Input/Output (I/O) 3, a liquid crystal display (LCD) 4, a USB 5, a digital-to-analog converter 6, a preamplifier 7, a sound volume output controller 8 and a postamplifier 9.

The central processing unit (CPU) 1 is provided for reading data of an audio file stored in the memory 2, sending the data to the digital-to-analog converter 6, processing the information of the user function keys, and displaying information on the liquid crystal display (LCD) 4 during the playback. The memory 2 is provided for storing one or more audio file formats, set-select Input/Output (I/O) 3 as an I/O unit, wherein a portion of the I/O is comprised of a plurality of press keys, so that a user can control the press keys to change the sequence of playing the songs, or even select a sound field. The liquid crystal display (LCD) 4 is provided for displaying the corresponding I/O function operated by users. The USB 5 is provided for connecting an interface of an external device. The digital-to-analog converter 6 is provided for converting digital and analog image signals for both input and output. As to the preamplifier 7, the sound volume output controller 8, and the postamplifier 9, the preamplifier 7 is responsible for controlling the switch of signals and the sound volume and the sound volume output controller 8 controls the overall sound output, and the postamplifier 9 amplifies the preamplifed signal to drive the earphone to produce sound. Since the foregoing components are not the technical characteristics of the present invention, they will not be described here.

The present invention is characterized in that two insert holes are disposed on the exterior of a body of a digital music player, and the insert holes are an earphone output hole and a microphone (Mic or Line-in) input hole 10, and a select switch 12 and a signal sensitivity adjusting knob 11 are added, wherein the select switch 12 is provided for switching a play function at the input hole for a microphone (Mic) or a recording function at the input hole for a Line-in, and the signal sensitivity adjusting knob 11 is provided for adjusting the output sound volume of the microphone (Mic or Line-in).

When the invention is in use, the plugs of the earphone and the microphone of the earphone-microphone module are plugged respectively into the earphone output hole and a new input hole. After a user wears the earphone-microphone module, the user can sing along with the music while listening to the music, since there is an extra microphone Mic for the play function that can integrate the user's song with the music and send the sound to the user's ear. The input sound volume of the microphone can be adjusted by the signal sensitivity adjusting knob 11, so that the sound can be boosted or the background sound can be reduced to achieve an entertaining effect similar to portable KTV or Karaoke.

In addition, a user can select the language learning function, such that the user can follow or repeat the pronunciation of new words, and make proper corrections if needed, since the user can clearly listen to his/her own voice, so as to greatly improve the language learning effect. Furthermore, users can correct any mistake made in the process of learning a language if they can hear their own voice clearly, and thus the present invention can significantly improve the learning effect.

Further, the portable earphone-microphone type digital music player capable of playing MIC sounds of the invention provides the microphone (Mic or Line-in) input hole 10, select switch 12 and signal sensitivity adjusting knob 11 can be applied for integrating various different devices such as a mobile phone, a digital camera and a personal digital assistant (PDA) to achieve the diversified functions.

In summation of the above description, the portable earphone-microphone type digital music player capable of playing MIC sounds in accordance with present invention definitely achieves the expected objective and provides a portable earphone-microphone type digital music player to enhance the performance over the prior art. The invention further complies with the patent application requirements and is duly filed for the patent application.

What is claimed is:

1. A portable earphone-microphone type digital music player capable of playing MIC sounds, comprising two insert holes disposed outside a body of said digital music player, wherein said two insert holes are an earphone output hole and a microphone (Mic or Line-in) input hole, and a select switch and a signal sensitivity adjusting knob are provided for switching a play function of said microphone or a recording function of said Line-in microphone, and adjusting the input of a sound volume of said microphone or Line-in.

2. The portable earphone-microphone type digital music player capable of playing MIC sounds of claim 1, wherein said microphone (Mic or Line-in) input hole, select switch and signal sensitivity adjusting knob can be applied to a mobile phone, a digital camera, or a personal digital assistant (PDA).
